(19) United States
(12) Patent Application Publication
(10) Pub. No.: US 2009/0086985 A1
(43) Pub. Date: Apr. 2, 2009

(54) Apparatus and method for testing audio jacks of sound card

(75) Inventors: Ding-Hao Zhang, Tianjin (CN); Ding-Zhuo Wang, Tianjin (CN); Zhong Shi, Tianjin (CN); Tom Chen, Taipei (TW); Win-Harn Liu, Taipei (TW)

Correspondence Address: RABIN & Berdo, PC, 1101 14TH STREET, NW, SUITE 500, WASHINGTON, DC, 20005, US

(73) Assignee: INVENTEC CORPORATION, Taipei (TW)

(21) Appl. No.: 11/905,335

(22) Filed: Sep. 28, 2007

(51) Int. Cl. H04R 29/00

(52) U.S. Cl. 381/58

(57) ABSTRACT

An apparatus and a method for testing audio jacks of a sound card are applicable for detecting whether at least one audio jack of the sound card in a personal computer (PC) sounds normally. Each audio jack provides at least one sound channel for transmitting a sound signal. The testing system includes driving circuits and a plurality of light-emitting units. The driving circuits are electrically connected to the sound card and an external voltage source, and used to change a current transmitting path according to the received sound signal. The light-emitting units are electrically connected to the driving circuits, and receive the current generated from the driving circuit, such that the light-emitting units emit lights. A sound channel to be tested is selected first, and a sound signal is sent to the sound channel. After the testing apparatus receives the sound signal, the light-emitting units emit lights.

### BACKGROUND OF THE INVENTION

1. Field of the Invention

The present invention relates to an apparatus and a method for testing audio jacks of a sound card. More particularly, the present invention relates to a system and a method for testing a multi-channel sound card through using light-emitting elements.

2. Related Art

As the operating speed of a personal computer (PC) is increasingly enhanced, the PC also begins to provide more powerful multi-media entertainment. For example, as for MPEG-series audio/video (AV) playing capability, it has developed from MPEG-1, a dual-channel film, with a resolution of 320*240 used by VCD in the past to MPEG-2, 5.1-channel film, with a resolution of 720*480 used by DVD recently. The PC not only supports the processing of films with higher resolution, but the sound processing is also improved.

Generally, a current sound card at least provides a dual-channel output, but even provides 2.1, 5.1 or 7.1 channel output, so as to match with better AV effect. The multi-channel means that sounds are made from each channel independently. Generally, just a two-channel loudspeaker can simulate a stereophonic effect.

Referring to FIG. 1, it is a schematic view of a 7.1-channel speaker. The multi-channel output is usually indicated by “x.1”, in which “x” refers to “x” surround speakers, and “0.1” refers to a subwoofer speaker. The 7.1-channel speaker has a right front speaker, a left front speaker, a centre speaker, a left speaker, a right speaker, a right rear speaker, a left rear speaker, and a subwoofer speaker respectively. Compared with the 7.1-channel speaker, a 5.1-channel speaker does not have the left speaker and the right speaker, and a 4-channel speaker or a 4.1-channel speaker does not have the centre speaker.

Through the simulating operation to the AV environment by a PC 110, when the user watches the film or plays games, the multi-channel speaker can provide an emulation effect. Definitely, if there are more surround speakers, an acoustic environment with more accurate positioning effects can be provided.

The common manufacturers detect whether a sound card 120 can operate normally or not through a manual monitoring manner. Taking a dual-channel sound card 120 for example, it is only necessary for testers to monitor the sounds of the two channels, so as to determine whether the sound card 120 operates normally. However, as for a multi-channel sound card 120, such a testing method easily causes the following defects: the first problem that may occur is the connection of the signal lines, and the second problem is the testers' determination.

It is quite time-consuming to serially connect the multi-channel sound card 120 with all the speakers. During the assembling process, if the tester assembles the speakers incorrectly by accident, the sounding dislocation may occur for the speakers that make sounds. In addition, it requires quite a large site to test the surround sound field of the multi-channel speaker. The most troublesome matter is that, once being surrounded by the multi-channel speakers, the tester cannot easily identify the problematic speaker. Therefore, it is quite difficult to test the multi-channel sound card 120.

### SUMMARY OF THE INVENTION

In view of the above problems, the object of present invention is provided with a system for testing audio jacks of a sound card, applicable for detecting whether a plurality of channels of the sound card sounds normally or not, in which the lights emitted from light-emitting elements are used to determine whether a corresponding channel sounds normally.

In order to achieve the above object, the present invention provides a testing system, which includes driving circuits and light-emitting elements. The driving circuits are electrically connected to an audio signal converting unit, and send a current according to a received simulate signal. The light-emitting elements are electrically connected to the driving circuits, and receive the current from the driving circuits, such that the light-emitting elements are driven to emit lights.

From another aspect of the present invention, the present invention provides a method for testing channels of a sound card, applicable for detecting whether a plurality of channels of the sound card operates normally or leaks sounds or not, in which the lights emitted from the light-emitting elements are used to determine whether the corresponding channel sounds normally or not. The test method includes the following steps.

A plurality of driving circuits and a plurality of light-emitting elements are provided. The driving circuits are electrically connected between the sound card and the light-emitting elements. The driving circuits drive the light-emitting elements to emit lights according to the sound signal.

In the present invention, the light-emitting elements are taken as the reference for indicating the test results of the channels of the sound card. The tester can determine whether the audio jacks corresponding to the sound channels operate normally or not according to the lights emitting from the light-emitting elements. Similarly, it can detect whether the sound leakage problem occurs between the sound channels.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, which thus is not limitative of the present invention, and wherein:

FIG. 1 is a schematic view of a 7.1-channel speaker;

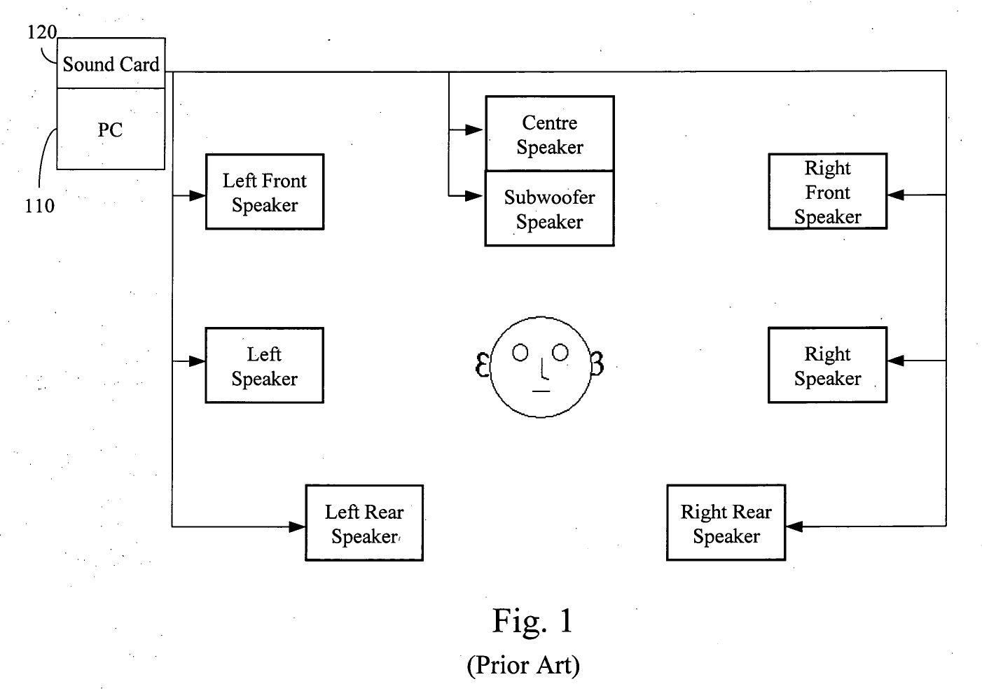

FIG. 2 is a schematic view of the connection of an apparatus for testing audio jacks of a sound card according to the present invention;

FIG. 3 is a schematic view of the flow of a method for testing the sound card according to the present invention;

FIG. 4a is a schematic view of the testing apparatus connected to the 7.1 channel according to the present invention; and

FIG. 4b is a schematic view of a driving circuit according to the present invention.

### DETAILED DESCRIPTION OF THE INVENTION

The present invention is directed to an apparatus for testing audio jacks of a sound card, which is applicable for detecting whether at least one audio jack of the sound card in the PC 210 can sound normally. Each audio jack of the sound card provides at least one sound channel, and each sound channel is used to transmit the sound signal. The common sound card provides 2-channel, 2.1-channel, 4-channel, 4.1-channel, 5.1-channel, or 7.1-channel functions. If the number of the channels becomes larger, it indicates that a corresponding number of speakers can be assembled, so as to provide more accurate sound positioning function.

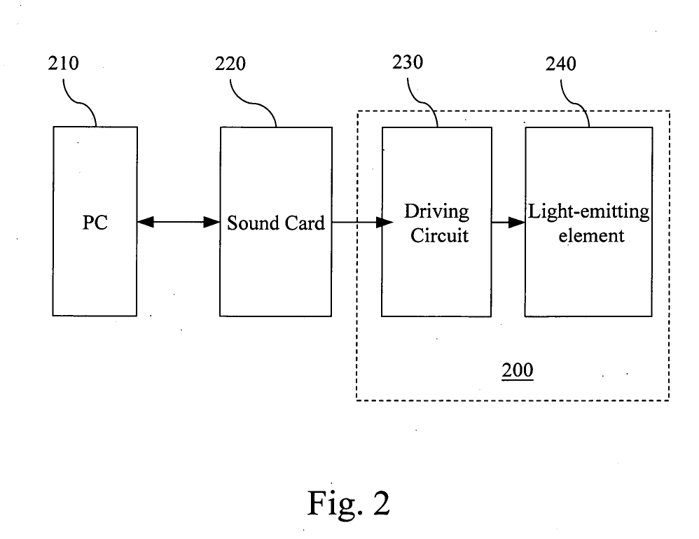

The apparatus 200 for testing audio jacks of the sound card 220 of the present invention includes driving circuits 230 and light-emitting elements 240. As shown in FIG. 2, it is a schematic view of the connection of an apparatus for testing audio jacks of a sound card according to the present invention. The driving circuits 230 are electrically connected to the sound card 220 and an external voltage source, and used to change a current transmitting path in the driving circuits 230 according to the received sound signal. The sound signal can be, but not limited to, a sine wave. The light-emitting elements 240 are electrically connected to the driving circuits 230, and used to receive the current generated from the driving circuits 230, such that the light-emitting elements 240 are driven to emit lights. The light-emitting elements 240 can be light emitting diodes (LEDs) or other electroluminescent elements, and the light-emitting elements 240 can adopt a corresponding color for indicating the test result, depending upon difference sound channels. For example, the front speaker can be indicated through a red light-emitting element 240, and the rear speaker can be indicated through a blue light-emitting element 240.

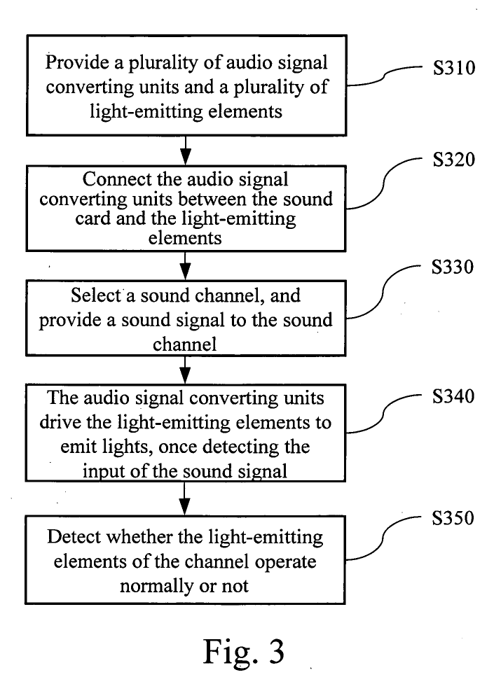

Referring to FIG. 3, it is a schematic view of the flow of a method for testing the sound card according to the present invention. Firstly, a plurality of driving circuits and a plurality of light-emitting elements are provided (Step S310). Next, the driving circuits are electrically connected between the sound card and the light-emitting elements (Step S320). Then, a sound channel is selected, and then a sound signal is provided to the sound channel (Step S330), and the sound signal is continuously played for a fixed period. The driving circuits drive the light-emitting elements to emit lights according to the sound signal (Step S340). It is detected whether the light-emitting elements of the sound channel operate normally or not (Step S350). If yes, Step S330 is repeated until all the sound channels are detected.

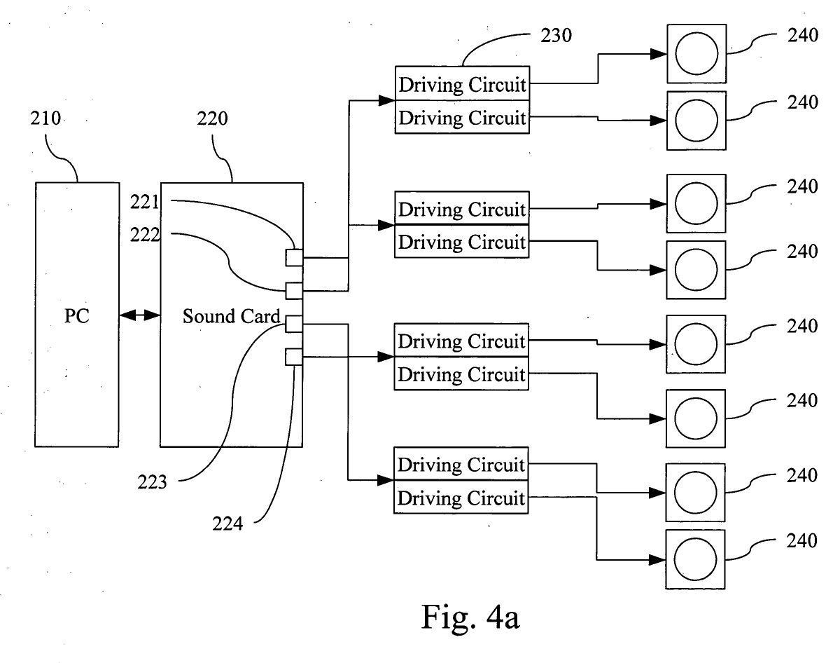

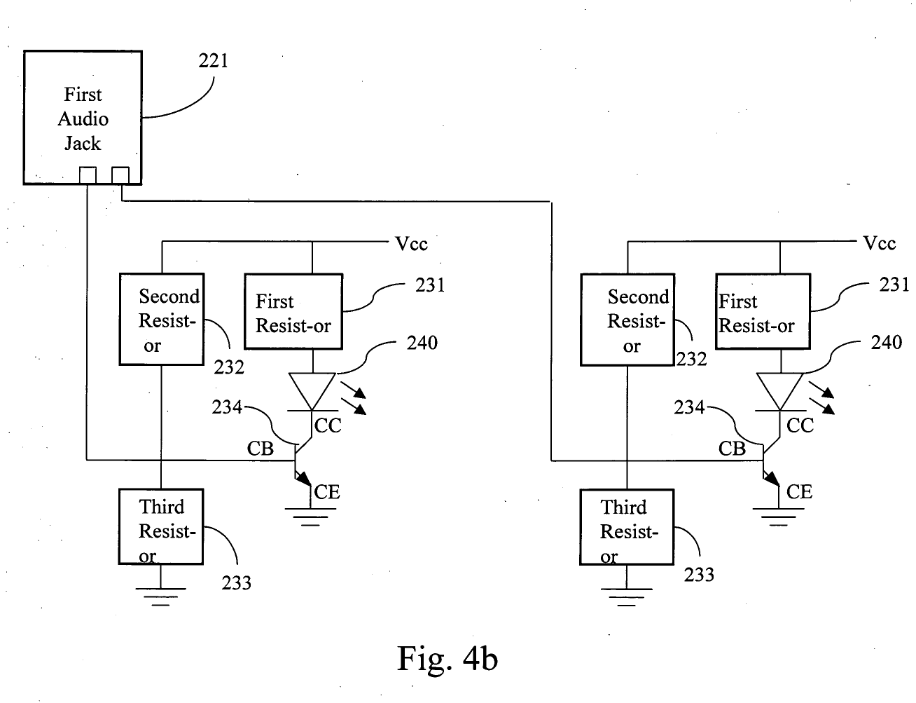

In order to clearly illustrate the spirit of the present invention, referring to FIGS. 3, 4a, and 4b. FIGS. 4a and 4b are respectively a schematic view of the testing apparatus connected to the 7.1 channel according to the present invention and a schematic view of a driving circuit according to the present invention. In FIG. 4a, each sound channel is correspondingly connected to a group of driving circuits 230 and light-emitting elements 240.

In FIG. 4b, two sound channels of the right front speaker and the left front speaker are taken as the example. In this embodiment of the present invention, the 7.1-channel sound card 220 provides four audio jacks, namely, a first audio jack 221, a second audio jack 222, a third audio jack 223, and a fourth audio jack 224. The first audio jack 221 provides the sound channels of the right front speaker and the left front speaker respectively. The second audio jack 222 provides the sound channels of the left speaker and the right speaker respectively. The third audio jack 223 provides the sound channels of the right rear speaker and the left rear speaker respectively. The fourth audio jack 224 provides the sound channels of the centre speaker and the subwoofer speaker.

Here, a preferred embodiment is provided to clearly illustrate the spirit of the present invention, but the present invention is not limited to the circuit. Taking the first audio jack 221 as an example, the testing apparatus 200 is connected to the first audio jack 221. Each driving circuit 230 includes a first resistor 231, a second resistor 232, a third resistor 233, and a transistor 234 respectively. Different light-emitting elements 240 require different voltages, so the combination ratio of the second resistor 232 to the third resistor 233 can also be different. The transistor 234 can be, but not limited to, Q32N3904. A common-emitter (CE) of the transistor 234 is connected to a ground terminal. The light-emitting elements 240 and the first resistor 231 are connected between a common-collector (CC) of the transistor 234 and the external voltage source. The second resistor 232 and the third resistor 233 are connected between the external power source terminal and the ground terminal. A common-base (CB) of the transistor 234 is connected to the first audio jack 221. The second resistor 232 and the third resistor 233 in the driving circuit 230 form a bias circuit. When the first audio jack 221 begins to send a sound signal, the light-emitting element 240 is driven to emit lights.

For example, if the external voltage source is 5 V and the operating voltage of the transistor 234 is 0.7 V, the bias circuit formed by the second resistor 232 and the third resistor 233 makes the voltage applied on the third resistor 233 to be slightly lower than 0.7 V. At this time, the transistor 234 is not conducted, and the light-emitting element 240 is not driven to emit lights. When the first audio jack 221 begins to send a sound signal, the operating voltage of the third resistor 233 is higher than 0.7 V, and at this time, the transistor 234 is conducted, such that the light-emitting element 240 is driven to emit lights. If the sound signal is a sine wave, due to the simplicity and the quickly-changed waveforms of the sine wave, it stably drive the light-emitting element 240 to have a stable luminance. If the intensity of the sound signal is adjusted, the luminance of the light-emitting element 240 is changed accordingly. The higher the intensity of the sound signal is, the greater the luminance of the light-emitting element 240 is, and vise versa.

In the present invention, besides using the light-emitting element 240 to detect whether the sound channels of the sound card 220 operate normally, a voltmeter can be additionally connected to the CE of the transistor 234. During the detecting process, if it is found that the light-emitting element 240 emit lights or the voltmeter has changes in reading under the circumstance that no sound signals are sent via the sound channel, it indicates that a certain problem occurs in the audio jack corresponding to this sound channel, for example, sound leakage or misconnection of the audio interface.

In the testing apparatus 200 of the present invention, the light-emitting elements 240 are taken as the reference for indicating the test results of the channels of the sound card. The tester can determine whether the audio jacks corresponding to the sound channels operate normally or not according to the lights emitting from the light-emitting elements. Similarly, it can detect whether the sound leakage problem occurs between the sound channels.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An apparatus for testing audio jacks of a sound card, applicable for detecting whether at least one audio jack of a sound card sounds normally or not, wherein each audio jack comprises at least one sound channel for transmitting a sound signal, the apparatus comprising:
a plurality of driving circuits, electrically connected to the sound card and an external voltage source, for changing a current transmitting path in the driving circuits according to the received sound signal;
a plurality of light-emitting elements, electrically connected to the driving circuits, for receiving a current generated from the driving circuits, such that the light-emitting elements are driven to emit lights.

2. The apparatus for testing audio jacks of the sound card as claimed in claim 1, wherein the sound card provides 2-channel, 2.1-channel, 4-channel, 4.1-channel, 5.1-channel, or 7.1-channel functions.

3. The apparatus for testing audio jacks of the sound card as claimed in claim 1, wherein the light-emitting elements are one light-emitting element.

4. The apparatus for testing audio jacks of the sound card as claimed in claim 1, wherein the sound signal is a sine wave.

5. The apparatus for testing audio jacks of the sound card as claimed in claim 1, wherein the light-emitting elements determine the luminance according to the intensity of the sound signal.

6. The apparatus for testing audio jacks of the sound card as claimed in claim 1, wherein the testing apparatus further comprises a voltmeter, electrically connected to the driving circuits, for indicating the intensity of the sound signal.

7. A method for testing audio jacks of a sound card, applicable for detecting whether a plurality of channels provided by an audio jack of a sound card sounds normally or not, wherein each audio jack provides at least one sound channel for transmitting a sound signal, the testing method comprising:
providing a plurality of driving circuits and a plurality of light-emitting elements;
electrically connecting the driving circuits between the sound card and the light-emitting elements; and
driving the light-emitting elements to emit lights by the driving circuits according to the sound signal.

8. The method for testing audio jacks of the sound card as claimed in claim 7, further comprising:
receiving the sound signal by the driving circuits, and changing a current transmitting path in the driving circuits, so as to make the driving circuits output a current to drive the light-emitting elements to emit lights; and
providing a driving circuit for sending a current to drive the light-emitting elements to emit lights according to a received simulate signal.

9. The method for testing audio jacks of the sound card as claimed in claim 7, wherein the driving circuit further comprises an external voltage source, for driving the light-emitting elements to emit lights.

10. The method for testing audio jacks of the sound card as claimed in claim 7, wherein the light-emitting elements are one light-emitting element.

11. The method for testing audio jacks of the sound card as claimed in claim 7, wherein the sound signal is a sine wave.

12. The method for testing audio jacks of the sound card as claimed in claim 7, wherein the light-emitting elements determine the luminance according to the intensity of the sound signal.

13. The method for testing audio jacks of the sound card as claimed in claim 7, further providing a voltmeter, electrically connected to the driving circuits, for indicating the intensity of the sound signal.
